(19) United States
(12) Patent Application Publication
(10) Pub. No.: US 2023/0116554 A1
(43) Pub. Date: Apr. 13, 2023

(54) Techniques For Compiling High-Level Inline Code

(71) Applicant: Intel Corporation, Santa Clara, CA (US)

(72) Inventors: Gregg Baeckler, San Jose, CA (US); Martin Langhammer, Salisbury (GB)

(73) Assignee: Intel Corporation, Santa Clara, CA (US)

(21) Appl. No.: 18/077,170

(22) Filed: Dec. 7, 2022

(51) Int. Cl. G06F 8/41

(52) U.S. Cl. CPC G06F 8/4443; G06F 8/42

(57) ABSTRACT

A processor circuit includes a compiler configured to receive a software program that comprises software code coded in an assembly language and inline software code coded in a high-level programming language, compile the inline software code coded in the high-level programming language within the software program into assembly code in the assembly language, and compile the assembly code and the software code coded in the assembly language into machine code for the processor circuit. A method includes determining if first and second instructions in a software program are combinable into one instruction word, combining the first and the second instructions in the software program into one instruction word if the first and the second instructions are combinable, and fetching the instruction word into a single register by storing the instruction word in the single register.

### FIELD OF THE DISCLOSURE

The present disclosure relates to electronic circuits and systems, and more particularly, to techniques for compiling inline code in a high-level programming language and combining instructions in a program into one instruction word.

### BACKGROUND

Configurable logic integrated circuits can be configured by users to implement desired custom logic functions. In a typical scenario, a logic designer uses computer-aided design tools to design a custom circuit design. When the design process is complete, the computer-aided design tools generate configuration data. The configuration data is then loaded into configuration memory elements that configure configurable logic circuits in the integrated circuit to perform the functions of the custom circuit design. Configurable logic integrated circuits can be used for co-processing in big-data or fast-data applications. For example, configurable logic integrated circuits may be used in application acceleration tasks in a datacenter and may be reprogrammed during datacenter operation to perform different tasks.

### BRIEF DESCRIPTION OF THE DRAWINGS

FIG. 1 is a diagram that illustrates an example of an integrated circuit that includes a processor circuit that can implement various techniques disclosed herein.

FIG. 2 is a flow chart that illustrates examples of operations that can be performed by a compiler to combine together multiple instructions in a software program into one instruction word.

FIG. 3 is a flow chart that illustrates examples of operations that can be performed by an assembler to compile and execute an assembly code software program that includes inline software code written in a high-level programming language.

FIG. 4 is a diagram that illustrates an example of a programmable (configurable) logic integrated circuit (IC).

### DETAILED DESCRIPTION

This disclosure discusses integrated circuit devices, including configurable (programmable) logic integrated circuits such as field programmable gate arrays (FPGAs). As discussed herein, an integrated circuit (IC) may include hard logic and/or soft logic. As used herein, “hard logic” generally refers to circuits in an integrated circuit device that are not programmable by an end user. The circuits in an integrated circuit device (e.g., in a configurable IC) that are programmable by the end user are referred to as “soft logic.”

Small lightweight central processing units (CPUs), such as the soft logic processors used in many configurable logic integrated circuits (ICs), often do not support high-level programming languages, such as the C programming language. Standard embedded compilers and toolsets for C programs have been developed for several soft logic processors used in configurable logic ICs. The standard flow of a C program requires a large amount of overhead, including both programming and memory space for the compiled C program. The overhead for a compiled C program is often very large (e.g., uses a large amount of memory) compared to the soft logic resources that are ideally used for a compiled program.

Some applications provide inline assembly code support for a program written in the C programming language so that users can control the efficiency of critical code within the program. Writing assembly code is time consuming and takes a lot of effort to debug and to maintain. High-level programming languages, such as C, are much easier to understand and to maintain. As discussed above, creating a C compiler for a lightweight CPU is challenging, because the inefficiencies of the C programming language require a lot of memory overhead compared to an assembly code compiler.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

According to some examples disclosed herein, systems and methods for processors provide support for inline high-level programming languages within a software program written in assembly language. The software program is compiled by an assembler that compiles the assembly code in the software program. The assembler includes a high-level programming language compiler that compiles inline code in the software program written in the high-level programmable language. The inline code can be written in a high-level programming language such as, for example, the C programming language or a hardware description language (HDL) for a configurable logic integrated circuit. Variable declarations are not needed in the inline high-level programming language, because the assembler can extract variables directly from the assembly code. The assembler converts the inline code written in the high-level programming language into assembly code. The assembly code is then run by a processor circuit in an integrated circuit, such as a soft logic processor in a configurable logic integrated circuit (IC).

According to other examples disclosed herein, a compiler that compiles code in a software program can combine two or more instructions in the software program into one instruction word to improve the efficiency of the software program. Each instruction word is stored in a single register in memory during an instruction fetch. Each instruction word can be processed by a processor circuit over one, two, or more clock cycles to allow for deeply pipelined access to the instructions.

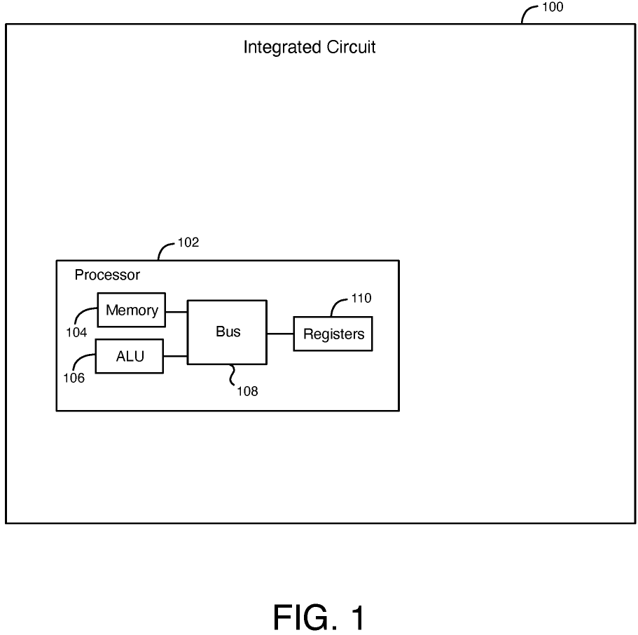

FIG. 1 is a diagram that illustrates an example of an integrated circuit 100 that includes a processor circuit 102 that can implement various techniques disclosed herein. The integrated circuit 100 shown in Figure (FIG. 1) can be a portion of an integrated circuit (IC) die or an entire IC die. In some implementations, the processor circuit 102 may not be drawn to scale in FIG. 1 with respect to the dimensions of IC 100. For example, processor circuit 102 may be much smaller than shown in FIG. 1 with respect to the size of IC 100. IC 100 can be any type of IC, such as, for example, a configurable logic IC (e.g., a field programmable gate array (FPGA)), a microprocessor IC, a graphics processing unit IC, an application specific IC, a memory IC, etc.

Processor circuit 102 can be a soft logic processor in a configurable logic IC or a hard logic processor. Processor circuit 102 includes one or more memory circuits 104, one or more arithmetic logic unit (ALU) circuits 106, a communication bus 108, and register circuits (registers) 110. Communication bus 108 is a bi-directional bus that can transmit data and instructions (e.g., software code) between two or more of memory circuits 104, ALU circuits 106, and register circuits 110, as disclosed in further detail below. The ALU circuits 106 can perform arithmetic and Boolean logic functions such as, for example, addition, multiplication, AND, OR, XOR, etc.

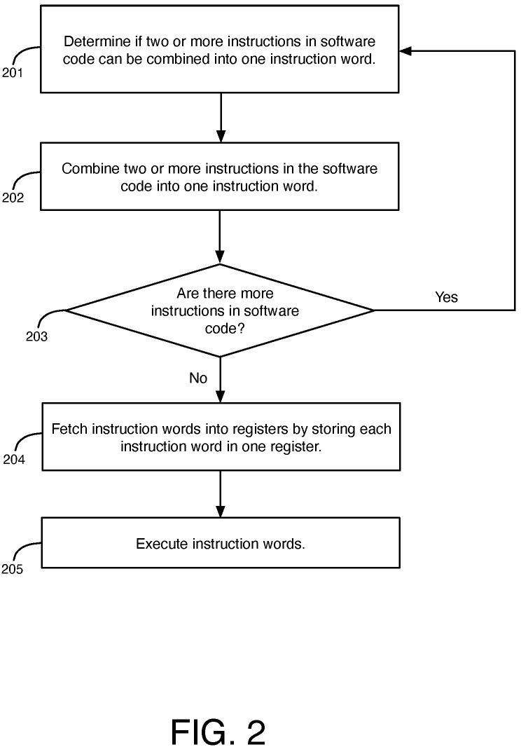

A processor circuit, such as processor circuit 102, can run a compiler, such as an assembler, that compiles code in a software program. The compiler can combine multiple instructions in a software program into one instruction word to improve the efficiency of the software program. FIG. 2 is a flow chart that illustrates examples of operations that can be performed by a compiler to combine together multiple instructions in a software program into one instruction word. The compiler that performs the operations of FIG. 2 can, for example, be an assembler that compiles assembly code for a software program written in an assembly language, or a compiler that compiles another type of software code. An assembly language is any low-level programming language that has a strong correlation between the instructions in the programming language and the machine code instructions for a processor circuit architecture. The compiler that performs the operations of FIG. 2 can be run by any processor circuit, such as processor circuit 102 of FIG. 1.

In operation 201, the compiler determines if two or more instructions in the software code of a software program can be combined together (i.e., are combinable) into one instruction word. One instruction word contains one or more instructions that are stored in a single register (e.g., an instruction register) during an instruction fetch by a processor circuit.

The compiler can apply various rules in operation 201 to determine if two or more instructions in the software program can be combined into a single instruction word. As an example, the compiler can determine in operation 201 if two or more instructions in the software program have data dependencies on each other (i.e., hazards). If the compiler determines that two or more instructions to be combined have data dependencies on each other, then the compiler can separate the instructions by enough time (e.g., by one or more instruction slots) to cause any data output by one instruction to be available before that data is used by one or more other dependent instructions. The compiler can, for example, insert one or more NOPs (no operations) between two instructions, if one of the instructions requires data that is output by the other instruction. The number of NOPs inserted between the instructions can be selected based on the amount of time needed for the first instruction to calculate the data and make the data available to the next instruction. The compiler can, for example, pack two instructions with data dependencies together (e.g., two additions) in adjacent instruction slots in an instruction word if the first instruction can generate output data that is made available to the second instruction before the second instruction begins execution.

The compiler can, for example, be an assembler that evaluates assembly language opcodes for combination into a single instruction word and that accounts for occasional pipeline limitations. According to this example, each of the instructions in the software program that the assembler evaluates in operation 201 is an opcode (i.e., an operation code) in an assembly language. The assembler automatically applies rules in operation 201 before determining how closely the instructions can be combined together. The assembler can, for example, apply a rule in operation 201 to cause jumps to be only initiated in the first two instruction slots of the instruction word, if the memory access performed by a jump to access data takes several clock cycles.

The assembler can also apply similar rules to branches and returns in assembly code so that branches and returns are not combined too closely together in an instruction word. For example, to get a conditional branch, a stack result can be loaded into a branch enable register, then the assembler can fetch a jump, but the assembler does not execute the jump, if the branch enable is false. Any jump, whether executed or not, restores the branch enable to true. For a multicycle operation, the assembler can insert a NOP between activities of the multicycle to achieve correct operation of the multicycle. For example, the assembler can insert an extra NOP into an add to store path.

In operation 202, the compiler (e.g., the assembler) combines two or more instructions in the software code into one single instruction word. As a specific example that is not intended to be limiting, the compiler can combine up to four 5-bit instructions into a single 20-bit instruction word in operation 202 subject to the rules applied in operation 201. Although it should be understood that the compiler can combine any number of two or more instructions in software code into a single instruction word in operation 202. The size of each instruction word is based on the physical size of a register that stores the instruction word during an instruction fetch. The instruction word and the register can be any size, as long as the register is able to store at least the number of bits in a single instruction word. As a specific example that is not intended to be limiting, the instruction word and the register can each be 20-bits long. Thus, in the example of FIG. 2, the compiler optimizes the grouping of instructions in software code into a single instruction word that is based on the physical size of a register that stores the instruction word during an instruction fetch to improve the efficiency of instruction fetching.

In operation 203, the compiler determines if there are more instructions in the software code to be evaluated for potentially being combined into a single instruction word. If the compiler determines that there are more instructions in the software code to be evaluated in operation 203, then the compiler repeats operations 201-202 for these instructions. If the compiler determines that there are no more instructions in the software code to be evaluated in operation 203, the compiler proceeds to operation 204.

In operation 204, the compiler (e.g., the assembler) fetches instruction words into the registers by storing each one of the instruction words into one of the registers. The instructions that were combined (i.e., packed) together into one single instruction word in operation 202 are fetched together by the compiler in operation 204 and stored in a single register. As an example, the compiler (e.g., the assembler) can be run by a host computer, and the compiler can store the instruction words that were generated in iterations of operation 202 into memory in the host computer. In operation 204, the compiler can, for example, fetch the instruction words from the memory and then store each of the instruction words in instruction memory in IC 100. As an example, each instruction word can be stored in a different one of the registers 110. Optimizing the grouping of multiple instructions in software code into one instruction word that is based on the physical size of the register that stores the instruction word during instruction fetching as discussed above with respect to operation 202 greatly improves the efficiency of instruction fetching in operation 204. For example, optimizing the grouping of instructions into one instruction word can significantly reduce the amount of circuitry used to perform operation 204. In operation 205, the processor circuit executes the fetched instruction words in the software code.

According to other examples, an assembler is provided that can compile and execute an assembly code software program that includes inline software code coded in a high-level programming language. The inline software code is embedded within the assembly code software program. The assembler includes a compiler that compiles the inline software code in the assembly code software program that is coded in the high-level programmable language.

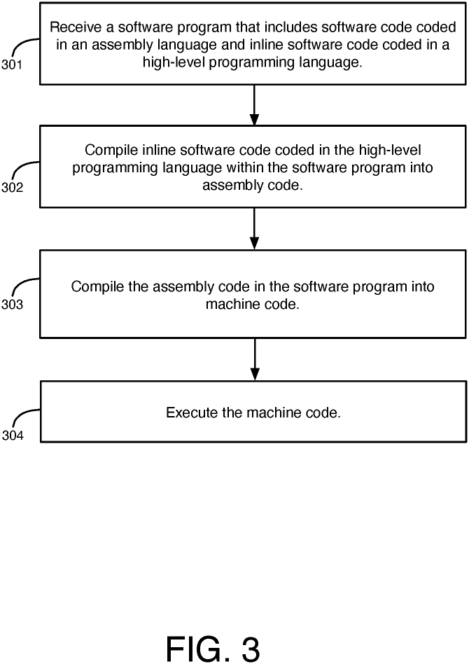

FIG. 3 is a flow chart that illustrates examples of operations that can be performed by an assembler to compile and execute an assembly code software program that includes inline software code coded in a high-level programming language. The assembler includes a compiler that can compile and execute opcodes in a software program coded in an assembly language. The assembler also includes a modified high-level programming language compiler that can compile the inline software code coded in the high-level programming language into assembly language opcodes that can be compiled by the assembler. The modified high-level programming language compiler can compile inline software code coded in any high-level programming language. The modified high-level programming language compiler can compile inline software code coded in a high-level programming language that supports software functions such as, for example, the C programming language. The modified high-level programming language compiler can also, or alternatively, compile inline software code coded in a high-level programming language that maps code directly to hardware circuits in an IC, such as, for example, a hardware description language (HDL) for a configurable logic integrated circuit. The assembler that performs the operations of FIG. 3 can be run by any processor circuit, such as processor circuit 102 of FIG. 1.

Initially, in operation 301, the assembler receives a software program that includes software code coded in an assembly language and inline software code coded in a high-level programming language. In operation 302, the modified high-level programming language compiler in the assembler compiles the inline software code coded in the high-level programming language within the software program into assembly code (e.g., into assembly opcodes). In order to perform operation 302, the assembler can, for example, identify the inline software code in the software program based on a predefined identifier that is placed at the start of each line of the inline software code. As a specific example that is not intended to be limiting, the identifier #C can be placed at the beginning of each line of the inline software code in the software program so that the assembler can determine which lines of software code in the software program are coded in the high-level programming language (e.g., C or HDL).

In operation 303, the assembler compiles the assembly code in the software program into machine code. The assembly code that the assembler compiles into the machine code in operation 303 includes the software code that was originally coded in the assembly language in the software program and the assembly code compiled in operation 302 from the inline software code originally coded in the high-level programming language. In operation 304, the processor circuit executes the machine code generated in operation 303 to implement the operations of the software program.

Specific examples are provided below of inline software code within a software program containing assembly language software code that can be compiled by an assembler. It should be understood that these examples are provided for the purpose of illustration and are not intended to be limiting. In these examples, locations in a scratch memory (e.g., memory 104) are explicitly defined and labeled using the assembler. An RC4 stream cipher is provided below as an example to illustrate inline software code coded in the C programming language within an assembly language software program. According to this example, the following code defines memory locations, and a function ADDR_SBOX points to the base of the sbox. The following location (i.e., at 0x200) is manually defined to avoid an array overwrite.
scratch addr_n = 3
scratch addr_i = 4
scratch addr_j = 5
scratch addr_key = 6
scratch addr_sbox = 0x100

Below are some examples of software code coded in an assembly language. In the examples of the software code provided below, the $ sign delineates the start of a new instruction word that can contain multiple instructions and that is stored in, and accessed from, a single register in memory during a fetch, according to the operations of FIG. 2.

$ lit0.15 addr_my_id
$ @scr
lit0.10 addr_auxvar0
$ !ext
drop
nop
nop

In this example, the main processing loop is coded in the C programming language. Lines of software code that are coded in the C programming language are identified by the prefix “#C” in the following code.

rc4_generate:
#C i = (i+1) & 0xff;
#C j = (j+sbox[i]) & 0xff;
call(swap)
#C tmp = sbox[(sbox[i] + sbox[j]) & 0xff];
$ ret
jmp
nop

In some examples, the assembler does not support functions specific to the C programming language. Instead, the software program can include calls to software code that is coded in the C programming language. All data transfers are implied through the scratch memory (i.e. the scratch memory acts as a C global scope variable). All data transfers are directly read and written by the called function. With respect to the function call “call(swap)”, swap can be a function either in the assembly or C programming language, or a combination of the two programming languages. The software code for the swap function is provided below.

#C tmp = sbox[i];
#C sbox[i] = sbox[j];
#C sbox[j] = tmp;
$ ret
jmp
nop
nop

The compiled code for the rc4_generate code is shown below, including 27 assembly code instructions that have been packed together according to the operations of FIG. 2.

rc4_generate :
//#C i = (i+1) & 0xff;
$0x076: lit0.15 0x4
$0x077: @scr
nop
nop
nop
$0x078: lit0.15 0x1
$0x079:+
lobyte
nop
nop
$0x07a: lit0. 15 0x4 // addr 4 is i
$0x07b: ! scr
drop
nop
nop
//#C j = (j+sbox[i]) & 0xff
$0x07c: lit0. 15 0x5 // fetch j
$0x07d: @scr
lit0.10 0x4
$0x07e: @scr
lit0.10 0x100 // sbox
$0x07f: +
nop
@scr // fetch sbox[i]
nop
$0x080:+
lobyte // & ff
nop
nop
$0x081: lit0.15 0x5
$0x082: !scr // save to J
drop
nop
nop
// call swap
$0x083: lit_to_rs0.15 0x85
$0x084: jmp. 15 0x1f
//#C tmp = sbox[(sbox[i] + sbox[j]) & 0xff];
$0x085: lit0.15 0x4
$0x086: @scr
lit0.10 0x100
$0x087:+
nop
@scr //fetch sbox[i]
nop
$0x088: lit0.15 0x5
$0x089: @scr
lit0.10 0x100
$0x08a: +
nop
@scr //fetch sbox[j]
nop
$0x08b: +
lobyte
nop
nop
$0x08c: lit0.15 0x100
$0x08d: +
nop
@scr //final sbox fetch
nop
// store to tmp
$0x08e: lit0.15 0x0
$0x08f: !scr
drop
nop
nop
// return from rc4_generate
$0x090: ret
jmp
nop
nop

In some implementations (e.g., for the software code provided above), the modified high-level programming language compiler in the assembler may not perform syntax (or grammar) checking of the inline software code coded in the high-level programming language (e.g., C or HDL). Instead, the modified high-level programming language compiler in the assembler refrains from generating errors for constructs in the inline software code that are syntactically illegal according to the syntax rules of the high-level programming language. The modified high-level programming language compiler may generate errors for lines of the inline software code that lack certain parameters. For example, the modified high-level programming language compiler can generate an error message for a line of code (e.g., “a = 0 + ”) that seeks another add input.

The assembly code compiler in the assembler defines the variables in the software program. Variable declarations are not needed in the inline software code coded in the high-level programming language, because the variables are extracted from the assembly code. The modified high-level programming language compiler searches within the variable declarations in the assembly code to identify the variables that are used in the inline software code. The modified high-level programming compiler can determine where these variables reside in memory from the assembly code, which can be useful for optimization. The assembler does not require that the variables in the inline software code be defined before use in the inline software code. The modified high-level programming language compiler can be programmed with a policy that always assumes that the inline software code is legal and that always attempts to compile the inline software code. If insufficient information is available regarding the variables in the inline software code, the modified high-level programming language compiler makes reasonable assumptions that the inline software code is legal, and then proceeds to compile the inline software code. If a variable is not assigned to a memory location in either the assembly code or in the inline software code, the assembler notes the variable and automatically assigns the variable to a free memory location. If the assembler is unable to reconcile some information in the compiled assembly code generated by the modified high-level programming language compiler, then the assembler can generate an error message.

The operation codes (opcodes) provided by a processor circuit for assembly language generally need to encompass a complete set of opcodes that is suitable for many programs. In some examples, the inline software code provided within an assembly language software program is coded in a hardware description language (HDL). In these examples, the assembler invokes HDL circuitry (e.g., logic gates) in the IC directly from within the software program (e.g., using logic gate level expressions). For example, logic circuitry in the IC can be coupled to an external bus or port in a data path with special load and store operations that access the external bus or port directly, with known cycle timing. In some examples, the external bus or port is the same external bus or port that is coupled to the ALU 106 of FIG. 1. More circuitry can be attached to the external bus/port via bus 108.

As a more specific example that is not intended to be limiting, a function that is repeatedly shifting values by 3 bits can attach inline HDL code within an assembly language software program that implements a wiring shift (e.g., aux_addr4 <= aux_addr3[15:0] << 3). If implemented in assembly language using the regular CPU data path, registers would have to be set up with the source data, distance = 3, call the shift operation, read the result down to the write of the source value (at aux_3) and readback (at aux 4). Instead, this function that is repeatedly shifting values by 3 bits can be attached to the external port for a single cycle operation using the inline HDL code. The inline HDL code can be attached to an assembly language software program by coding simple instructions to be added to the arithmetic logic unit 106 of FIG. 1. Although, this technique may increase the complexity of ALU 106, impacting timing closure.

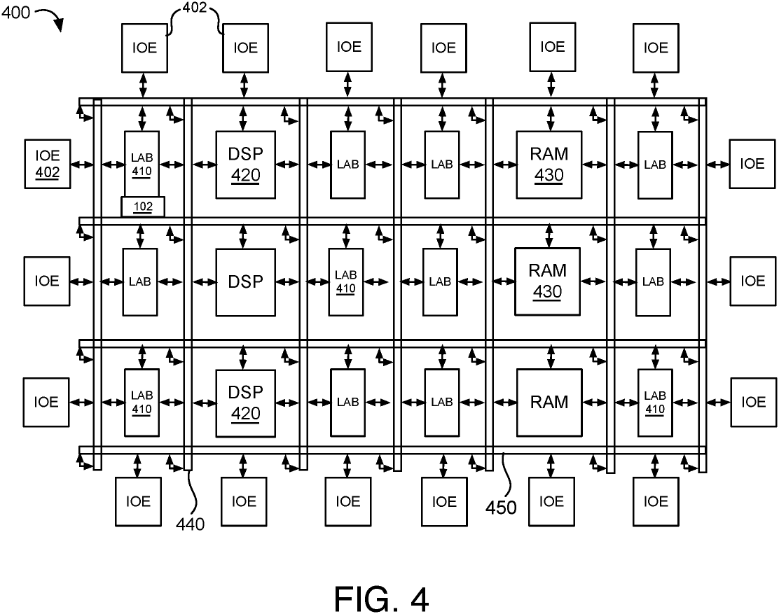

FIG. 4 is a diagram that illustrates an example of a programmable (configurable) logic integrated circuit (IC) 400. The programmable logic IC 400 is an example of the IC 100 of FIG. 1. As shown in FIG. 4, the programmable logic integrated circuit (IC) 400 includes a two-dimensional array of configurable functional circuit blocks, including configurable logic array blocks (LABs) 410 and other functional circuit blocks, such as random access memory (RAM) blocks 430 and digital signal processing (DSP) blocks 420. Functional blocks such as LABs 410 can include smaller programmable logic circuits (e.g., logic elements, logic blocks, or adaptive logic modules) that receive input signals and perform custom functions on the input signals to produce output signals. Programmable logic IC 400 also includes processor circuit 102.

In addition, programmable logic IC 400 can have input/output elements (IOEs) 402 for driving signals off of programmable logic IC 400 and for receiving signals from other devices. Input/output elements 402 may include parallel input/output circuitry, serial data transceiver circuitry, differential receiver and transmitter circuitry, or other circuitry used to connect one integrated circuit to another integrated circuit. As shown, input/output elements 402 may be located around the periphery of the chip. If desired, the programmable logic IC 400 may have input/output elements 402 arranged in different ways. For example, input/output elements 402 may form one or more columns, rows, or islands of input/output elements that may be located anywhere on the programmable logic IC 400.

The programmable logic IC 400 can also include programmable interconnect circuitry in the form of vertical routing channels 440 (i.e., interconnects formed along a vertical axis of programmable logic IC 400) and horizontal routing channels 450 (i.e., interconnects formed along a horizontal axis of programmable logic IC 400), each routing channel including at least one track to route at least one wire.

Note that other routing topologies, besides the topology of the interconnect circuitry depicted in FIG. 4, may be used. For example, the routing topology may include wires that travel diagonally or that travel horizontally and vertically along different parts of their extent as well as wires that are perpendicular to the device plane in the case of three dimensional integrated circuits. The driver of a wire may be located at a different point than one end of a wire.

Furthermore, it should be understood that embodiments disclosed herein with respect to FIGS. 1-3 may be implemented in any integrated circuit or electronic system. If desired, the functional blocks of such an integrated circuit may be arranged in more levels or layers in which multiple functional blocks are interconnected to form still larger blocks. Other device arrangements may use functional blocks that are not arranged in rows and columns.

Programmable logic IC 400 may contain programmable memory elements. Memory elements may be loaded with configuration data using input/output elements (IOEs) 402. Once loaded, the memory elements each provide a corresponding static control signal that controls the operation of an associated configurable functional block (e.g., LABs 410, DSP blocks 420, RAM blocks 430, or input/output elements 402).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory bits of the row that was designated by the address register.

In certain embodiments, programmable logic IC 400 may include configuration memory that is organized in sectors, whereby a sector may include the configuration RAM bits that specify the functions and/or interconnections of the subcomponents and wires in or crossing that sector. Each sector may include separate data and address registers.

The programmable logic IC of FIG. 4 is merely one example of an IC that can include embodiments disclosed herein. The embodiments disclosed herein may be incorporated into any suitable integrated circuit or system. For example, the embodiments disclosed herein may be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein may be stored in non-transitory computer readable storage media. Non-transitory computer readable storage media is tangible computer readable storage media that stores data and software code for access at a later time, as opposed to media that only transmits propagating electrical signals (e.g., wires). The software code may sometimes be referred to as software, data, program instructions, instructions, or code. The non-transitory computer readable storage media may, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s). The software code stored in the non-transitory computer readable storage media may be executed by a computing system that includes, for example, one or more integrated circuits, such as IC 100 or 400.

Additional examples are now described. Example 1 is a processor circuit comprising a compiler, wherein the compiler is configured to: receive a software program that comprises software code coded in an assembly language and inline software code coded in a high-level programming language; compile the inline software code coded in the high-level programming language within the software program into assembly code in the assembly language; and compile the assembly code and the software code coded in the assembly language into machine code for the processor circuit.

In Example 2, the processor circuit of Example 1 can optionally include, wherein the processor circuit is configured to execute the machine code.

In Example 3, the processor circuit of any one of Examples 1-2 can optionally include, wherein the compiler is further configured to compile the inline software code coded in a C programming language into the assembly code.

In Example 4, the processor circuit of any one of Examples 1-3 can optionally include, wherein the compiler is further configured to compile the inline software code coded in a hardware description language that maps to circuits into the assembly code.

In Example 5, the processor circuit of any one of Examples 1-4 can optionally include, wherein the compiler is further configured to identify the inline software code in the software program based on a predefined identifier that is placed at a start of each line of the inline software code.

In Example 6, the processor circuit of any one of Examples 1-5 can optionally include, wherein the compiler is further configured to refrain from generating errors for constructs in the inline software code that are syntactically illegal according to syntax rules of the high-level programming language.

In Example 7, the processor circuit of any one of Examples 1-6 can optionally include, wherein the compiler is further configured to extract variable declarations from the software code coded in the assembly language to identify variables used in the inline software code.

In Example 8, the processor circuit of any one of Examples 1-7 can optionally include, wherein the compiler is further configured to combine at least two instructions in the software code coded in the assembly language into one instruction word, and the processor circuit is configured to fetch the instruction word to a single register.

Example 9 is a method for compiling an assembly language program comprising inline software code coded in a high-level programming language, the method comprising: receiving the assembly language program that comprises first assembly code coded in an assembly language and the inline software code coded in the high-level programming language; compiling the inline software code coded in the high-level programming language into second assembly code; and compiling the first assembly code and the second assembly code into machine code for a processor circuit.

In Example 10, the method of Example 9 can optionally include, wherein compiling the inline software code into the second assembly code comprises compiling the inline software code coded in a hardware description language that maps to circuits into the second assembly code.

In Example 11, the method of any one of Examples 9-10 can optionally include, wherein compiling the inline software code into the second assembly code comprises compiling the inline software code coded in a C programming language into the second assembly code.

In Example 12, the method of any one of Examples 9-11 can optionally include, wherein compiling the inline software code into the second assembly code comprises refraining from generating errors for constructs in the inline software code that are syntactically illegal according to syntax rules of the high-level programming language.

In Example 13, the method of any one of Examples 9-12 can optionally include, wherein compiling the inline software code into the second assembly code comprises extracting variable declarations from the first assembly code to identify variables used in the inline software code.

In Example 14, the method of any one of Examples 9-13 can optionally include, wherein compiling the first assembly code and the second assembly code into the machine code comprises combining at least two instructions in the first assembly code into one instruction word that is fetched by the processor circuit from a single register.

In Example 15, the method of any one of Examples 9-14 can optionally include, wherein compiling the first assembly code and the second assembly code into the machine code comprises combining at least two instructions in the second assembly code into one instruction word that is fetched by the processor circuit from one register.

Example 16 is a non-transitory computer readable storage medium comprising code stored thereon for causing a processor circuit to execute a method for compiling a software program, wherein the code causes the processor circuit to: determine if first and second instructions in the software program are combinable into one instruction word; combine the first and the second instructions in the software program into the one instruction word if the first and the second instructions are combinable; and fetch the one instruction word into a single register by storing the one instruction word in the single register.

In Example 17, the non-transitory computer readable storage medium of Example 16 can optionally include, wherein the code further causes the processor circuit to: determine if the first and the second instructions are combinable into the one instruction word based on whether the second instruction uses data generated by the first instruction.

In Example 18, the non-transitory computer readable storage medium of any one of Examples 16-17 can optionally include, wherein the code further causes the processor circuit to: determine if the first and the second instructions are combinable into the one instruction word based on whether the first instruction outputs data before the second instruction uses the data if the first and the second instructions are combined into the one instruction word.

In Example 19, the non-transitory computer readable storage medium of any one of Examples 16-18 can optionally include, wherein the code further causes the processor circuit to: apply rules to determine how closely the first and the second instructions are combinable in the one instruction word that are based on time periods to execute the first and the second instructions.

In Example 20, the non-transitory computer readable storage medium of any one of Examples 16-19 can optionally include, wherein the method is performed by an assembler that compiles assembly code in an assembly language.

In Example 21, the non-transitory computer readable storage medium of any one of Examples 16-20 can optionally include, wherein the code further causes the processor circuit to: determine if the first instruction, the second instruction, and a third instruction in the software program are combinable into the one instruction word; and combine the first, the second, and the third instructions into the one instruction word if the first, the second, and the third instructions are combinable.

According to additional examples, any of the Examples 1-21 disclosed above can be implemented by a system or a processor circuit, or as a method, including as a method implemented by code stored on a non-transitory computer readable storage medium.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

What is claimed is:

1. A processor circuit comprising a compiler, wherein the compiler is configured to:
receive a software program that comprises software code coded in an assembly language and inline software code coded in a high-level programming language;
compile the inline software code coded in the high-level programming language within the software program into assembly code in the assembly language; and
compile the assembly code and the software code coded in the assembly language into machine code for the processor circuit.

2. The processor circuit of claim 1, wherein the processor circuit is configured to execute the machine code.

3. The processor circuit of claim 1, wherein the compiler is further configured to compile the inline software code coded in a C programming language into the assembly code.

4. The processor circuit of claim 1, wherein the compiler is further configured to compile the inline software code coded in a hardware description language that maps to circuits into the assembly code.

5. The processor circuit of claim 1, wherein the compiler is further configured to identify the inline software code in the software program based on a predefined identifier that is placed at a start of each line of the inline software code.

6. The processor circuit of claim 1, wherein the compiler is further configured to refrain from generating errors for constructs in the inline software code that are syntactically illegal according to syntax rules of the high-level programming language.

7. The processor circuit of claim 1, wherein the compiler is further configured to extract variable declarations from the software code coded in the assembly language to identify variables used in the inline software code.

8. The processor circuit of claim 1, wherein the compiler is further configured to combine at least two instructions in the software code coded in the assembly language into one instruction word, and the processor circuit is configured to fetch the instruction word to a single register.

9. A method for compiling an assembly language program comprising inline software code coded in a high-level programming language, the method comprising:
receiving the assembly language program that comprises first assembly code coded in an assembly language and the inline software code coded in the high-level programming language;
compiling the inline software code coded in the high-level programming language into second assembly code; and
compiling the first assembly code and the second assembly code into machine code for a processor circuit.

10. The method of claim 9, wherein compiling the inline software code into the second assembly code comprises compiling the inline software code coded in a hardware description language that maps to circuits into the second assembly code.

11. The method of claim 9, wherein compiling the inline software code into the second assembly code comprises compiling the inline software code coded in a C programming language into the second assembly code.

12. The method of claim 9, wherein compiling the inline software code into the second assembly code comprises refraining from generating errors for constructs in the inline software code that are syntactically illegal according to syntax rules of the high-level programming language.

13. The method of claim 9, wherein compiling the inline software code into the second assembly code comprises extracting variable declarations from the first assembly code to identify variables used in the inline software code.

14. The method of claim 9, wherein compiling the first assembly code and the second assembly code into the machine code comprises combining at least two instructions in the first assembly code into one instruction word that is fetched by the processor circuit from a single register.

15. The method of claim 9, wherein compiling the first assembly code and the second assembly code into the machine code comprises combining at least two instructions in the second assembly code into one instruction word that is fetched by the processor circuit from one register.

16. A non-transitory computer readable storage medium comprising code stored thereon for causing a processor circuit to execute a method for compiling a software program, wherein the code causes the processor circuit to:
determine if first and second instructions in the software program are combinable into one instruction word;
combine the first and the second instructions in the software program into the one instruction word if the first and the second instructions are combinable; and
fetch the one instruction word into a single register by storing the one instruction word in the single register.

17. The non-transitory computer readable storage medium of claim 16, wherein the code further causes the processor circuit to:
determine if the first and the second instructions are combinable into the one instruction word based on whether the second instruction uses data generated by the first instruction.

18. The non-transitory computer readable storage medium of claim 16, wherein the code further causes the processor circuit to:
determine if the first and the second instructions are combinable into the one instruction word based on whether the first instruction outputs data before the second instruction uses the data if the first and the second instructions are combined into the one instruction word.

19. The non-transitory computer readable storage medium of claim 16, wherein the code further causes the processor circuit to:
apply rules to determine how closely the first and the second instructions are combinable in the one instruction word that are based on time periods to execute the first and the second instructions.

20. The non-transitory computer readable storage medium of claim 16, wherein the method is performed by an assembler that compiles assembly code in an assembly language.

21. The non-transitory computer readable storage medium of claim 16, wherein the code further causes the processor circuit to:
determine if the first instruction, the second instruction, and a third instruction in the software program are combinable into the one instruction word; and
combine the first, the second, and the third instructions into the one instruction word if the first, the second, and the third instructions are combinable.
